(19) United States
(12) Patent Application Publication
(10) Pub. No.: US 2017/0292450 A1
(43) Pub. Date: Oct. 12, 2017

(54) GAS TURBINE ARRANGEMENT

(71) Applicant: DÜRR SYSTEMS AG, Bietigheim-Bissingen (DE)

(72) Inventors: Josip KUTNJAK, Bietigheim-Bissingen (DE); Urs ERTEL, Heimerdingen (DE); Axel WIDENHORN, Bietigheim-Bissingen (DE)

(21) Appl. No.: 15/517,389

(22) PCT Filed: Sep. 24, 2015
(86) PCT No.: PCT/EP2015/071985

§ 371 Date: Apr. 6, 2017

(30) Foreign Application Priority Data
Oct. 7, 2014 (DE) 102014220296.5

(51) Int. Cl. F02C 7/10; F02C 3/04; F02C 9/18; F02C 1/06

(52) U.S. Cl. CPC F02C 7/10; F02C 1/06; F02C 3/04; F02C 9/18; F05D 2220/32; F05D 2240/35; F05D 2240/60; F05D 2260/606

(57) ABSTRACT

A (micro) gas turbine arrangement includes a gas turbine device having a combustor system, a turbine driven by an exhaust gas stream of the combustor system, and a compressor for supplying the combustor system with a compressed oxidant stream, as well as a recuperator for transferring at least a portion of the thermal power of the exhaust gas stream of the turbine to the compressed oxidant stream. At least one bypass diverts at least a portion of the oxidant stream or the exhaust gas stream around at least one heat exchanger of the recuperator, and at least one control element for adjusting the flow through the at least one bypass, to be able to adapt the quantity of heat emitted by the gas turbine arrangement at the design point, and thus to be able to improve the efficiency of a power-heat cogeneration system having such a gas turbine arrangement.

The present invention relates to a gas turbine arrangement, in particular a micro gas turbine arrangement, and in particular (micro) gas turbine arrangements which can be used in power-heat cogeneration systems.

For the decentralized supply of for example companies with electrical, thermal and/or mechanical energy, more and more power-heat cogeneration systems are used which are operated with an internal combustion engine, in particular in the form of a micro gas turbine. Such micro gas turbines are gas turbines of lower power class, i.e. up to about 500 kW rated power. Power-heat cogeneration systems of this type are generally comprise also a power converter, in particular in the form of an electric generator, drivable by the internal combustion engine and a waste heat device for utilizing the waste heat in the exhaust gas of the internal combustion engine, in addition to the internal combustion engine itself.

Conventional gas turbines operate according to the open Joule or Brayton cycle. Gas turbines in a power range below 1 MW operate with a low pressure ratio because of otherwise low efficiencies in the compressor. Due to the low pressure ratio, great thermal losses are generated by the high exhaust gas temperature. However, the air temperature after compression is low compared to the exhaust gas temperature. In order to increase the electrical efficiency, it is known to heat the compressed air by the hot exhaust gas in a recuperator. Thus, less heat must be supplied to the compressed air by the combustion, whereby the electrical efficiency can be increased considerably.

Conventional gas turbine arrangements having micro gas turbines usually operate with fixed recuperation. I.e. the individual components of the micro gas turbine arrangement are designed for a predetermined operating point and matched to each other. In a fixed recuperation, however, the heat output of a micro gas turbine is not controllable, but the result of the operating point. With decreasing electric power, also the thermal waste heat capacity decreases, i.e. both the mass flow and the waste heat temperature. The waste heat temperature and the thermal power in the exhaust gas, however, are important operating parameters for the subsequent heat consumer or the downstream process.

The amount of heat of conventional micro gas turbine arrangements can only be adjusted by the operation of the micro gas turbine beyond the design point. This has the consequence that the efficiencies of the components and, as a result, also the total efficiency decrease. In addition, the conventional micro gas turbine arrangements are usually controlled by the outlet temperature of the turbine, which is usually in a range from 300° C. to 750° C., in particular between 450° C. and 700° C., for example at about 650° C.

Therefore, it is an object of the invention to provide an improved gas turbine arrangement which can be operated beyond a predetermined design point.

This object is achieved by the teaching of the independent claims. Particularly preferred configurations of the invention are subject-matter of the dependent claims.

The gas turbine arrangement according to the invention which is preferably configured as a micro gas turbine arrangement comprises: a gas turbine device comprising a combustor system, a turbine driven by an exhaust gas stream of the combustor system and a compressor for supplying the combustor system with a compressed oxidant stream; a recuperator for transferring at least a portion of the thermal power of the exhaust gas stream of the turbine to the compressed oxidant stream; at least one bypass for diverting at least a portion of the oxidant stream or the exhaust gas stream around at least one heat exchanger of the recuperator; and at least one control element for adjusting the flow through the at least one bypass.

In this gas turbine arrangement, at least a portion of the oxidant stream (=combustion air stream) or the exhaust gas stream can be diverted around at least one heat exchanger of the recuperator, if necessary. As a result thereof, the diverted portion of the oxidant or exhaust gas stream does not take part in the heat exchange in the recuperator so that, as a result, less heat is transferred from the exhaust gas stream to the oxidant stream and the temperature of the exhaust gas stream downstream of the recuperator can be increased. Thus, the gas turbine arrangement of the invention can adapt the amount of heat emitted in operation of the turbo-engine at the design point.

The direct exit of the exhaust gas stream from the gas turbine arrangement (exhaust gas-side bypass) without flowing through the recuperator, also reduces the temperature of the recuperator. As a result, the temperature load of the recuperator decreases, whereby its service life can be increased.

In a preferred configuration of the invention, at least one control element of the at least one control element is an adjustable control element, and the gas turbine arrangement comprises a control means for variably controlling the adjustable control element. Thus, the exhaust gas temperature and/or the emitted amount of heat of the gas turbine arrangement can be variably adapted to the respective requirements in an easy manner.

In a preferred configuration of the invention, at least one control element of the at least one control element is a fixed control element having a fixedly predetermined flow setting, which is selected specifically to the application. Thus, the exhaust gas temperature and/or the emitted amount of heat of the gas turbine arrangement can be easily adapted to the respective needs.

In a further preferred configuration of the invention, the recuperator is arranged in axial direction next to the gas turbine device, i.e. coaxially to it. The axial direction refers in particular to an axial direction of a turbine shaft of the gas turbine device. This preferred arrangement of the recuperator in relation to the gas turbine device preferably allows an axial inflow direction of the oxidant stream and the exhaust gas stream into the recuperator and preferably enables a gas turbine assembly having relatively low flow losses.

In an alternative preferred configuration of the invention, the recuperator can be arranged in radial direction (i.e. for example annular), preferably concentrically around the gas turbine device. In another alternative configuration of the invention, the two above-mentioned configurations can also be combined. I.e. the recuperator may be arranged partially in axial direction next to the gas turbine device and partially in radial direction around the gas turbine device.

In another preferred configuration of the invention, the at least one bypass is integrated into the recuperator. I.e. the at least one bypass is preferably arranged and formed within a housing or an outer shell of the recuperator. Thus, it is preferably possible to realize the at least one bypass without increasing the recuperator, without changing the external appearance of the recuperator and without additional external piping. As a result thereof, there is also preferably no need for other components of the gas turbine arrangement or a larger unit containing the gas turbine arrangement to be adapted to the additional bypasses, or additional heat insulation to be provided.

In a preferred configuration of the invention, at least one compressor-side bypass is provided, which connects a first inlet of the recuperator for the oxidant stream to a first outlet of the recuperator for the oxidant stream while bypassing the heat exchanger of the recuperator.

In another preferred configuration of the invention, at least an exhaust gas-side bypass is provided, which connects a second inlet of the recuperator for the exhaust gas stream to a second outlet of the recuperator for the exhaust gas stream while bypassing the heat exchanger of the recuperator.

The two above-mentioned configurations of the invention can preferably also be combined.

In the configuration of the gas turbine arrangement having at least one exhaust gas-side bypass, the recuperator preferably comprises a diffuser extending substantially concentrically to a turbine shaft of the gas turbine device which on its inlet side is connected to the second inlet of the recuperator for the exhaust gas stream, wherein the exhaust gas-side bypass is provided downstream of this diffuser. In alternative configurations of the invention, also radial diffusers may be provided or a diffuser can be set aside.

In the configuration of the gas turbine arrangement having at least one exhaust gas-side bypass, the recuperator preferably has an inner shell and an outer shell enclosing the inner shell, wherein the inner shell on its inlet side is connected to the second inlet of the recuperator and the outer shell on its outlet side is connected to the second outlet of the recuperator, and wherein the exhaust gas-side bypass connects the interior of the inner shell in radial direction to the interior of the outer shell.

In this afore-said configuration, the exhaust gas-side bypass preferably comprises at least two radial openings in the inner shell, and the control element preferably comprises a ring element being slidable in circumferential direction or in axial direction for selectively opening or closing the at least two radial openings. The selective opening or closing, in addition to a complete opening and a complete closing, preferably also includes a partial opening or closing.

In the configuration of the gas turbine arrangement having at least one exhaust gas-side bypass, alternatively, the recuperator preferably comprises an inner shell and an outer shell enclosing the inner shell, wherein the inner shell on its inlet side is connected to the second inlet of the recuperator and the outer shell on its outlet side is connected to the second outlet of the recuperator, and wherein the exhaust gas-side bypass connects the interior of the inner shell in axial direction with the interior of the outer shell.

In this configuration, the adjusting element for the exhaust gas-side bypass can preferably be integrated into the recuperator. Preferably, the integrated control element comprises a connection socket being fluidically connected to an axial opening in the inner shell, a valve flap arranged in the connection socket, and a further connection socket being fluidically connected to an intermediate space between the inner shell and the outer shell.

A recuperator for a gas turbine arrangement of the invention described above is also subject-matter of the invention.

Further, a power-heat cogeneration system comprising at least one gas turbine arrangement of the invention described above is subject-matter of the invention. The efficiency of such a power-heat cogeneration system can be significantly improved compared to conventional systems.

Advantageous application options of such a power-heat cogeneration system or its waste heat device are for example drying processes, steam generation, gas and ORC processes, gas and steam processes and the like.

The invention also relates to a method for operating a (micro) gas turbine arrangement comprising a gas turbine device having a combustor system, a turbine driven by an exhaust gas stream of the combustor system and a compressor for supplying the combustor system with a compressed oxidant stream, as well as a recuperator for transferring at least a portion of the thermal power of the exhaust gas stream of the turbine to the compressed oxidant stream, in which at least a portion of the oxidant stream and/or the exhaust gas stream are diverted around at least one heat exchanger of the recuperator by means of at least one bypass; and a flow through the at least one bypass is adjusted in an application specific and/or variable way.

With this operating method, the same advantages can be achieved as have been described above in connection with the gas turbine arrangement of the invention. The inventive method is preferably used for operating an above-described (micro) gas turbine arrangement of the invention.

The present invention may—depending on the configuration of the gas turbine device and depending on the type of embodiment—achieve one or more of the following advantages:
largely decoupling the heat emission from the electric power generation;
tunability of the exhaust gas temperature, adapted to the subsequent heat consumer;
possibility of controlling or regulating the heat emission during operation;
almost pressure lost neutral due to missing or at least only small deflections of the mass flows;
easy accessibility, particularly of the bypasses and their control elements, for modification or maintenance;
no changes visible from the outside;
no need for additional piping when using exhaust gas-side bypass;
good mixing of non-recuperated (hot) gases without direct contact to exhaust pipe;
guiding the hot gases inside (of the recuperator);
possibility of cross-flow mixture (i.e. streams meet each other transversely).

The above and further advantages, features and application options of the invention will be better understood from the following description of various embodiments with reference to the accompanying drawings, in which, largely schematically:

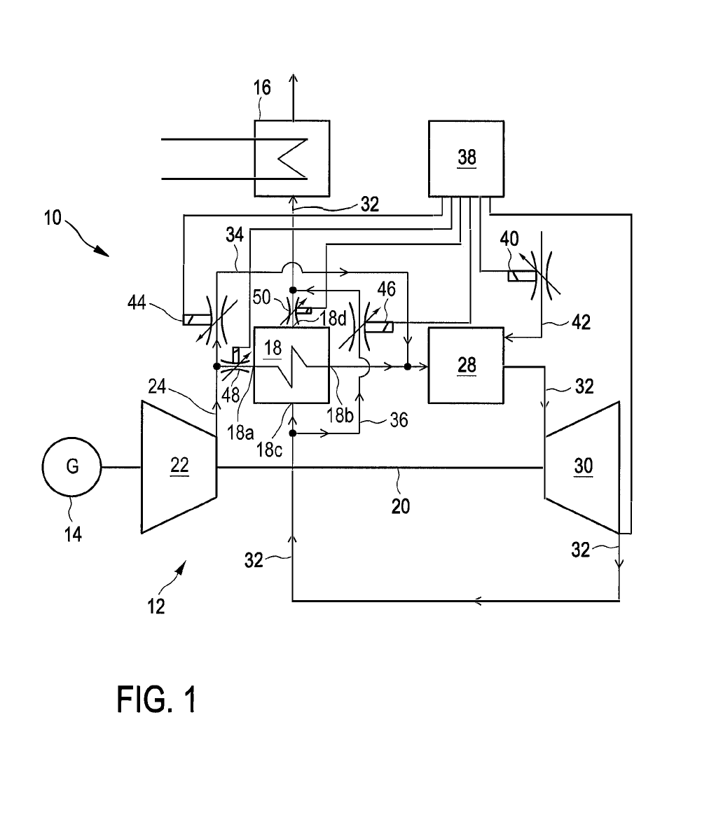

FIG. 1 is a block diagram of a power-heat cogeneration system including a gas turbine arrangement according to the present invention;

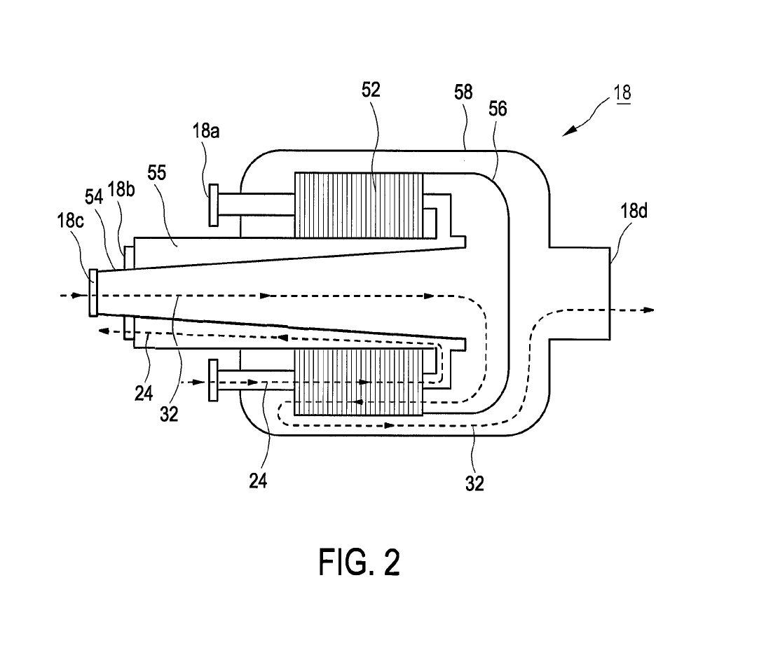

FIG. 2 is a simplified illustration of a preferred embodiment of a recuperator for a power-heat cogeneration system of FIG. 1;

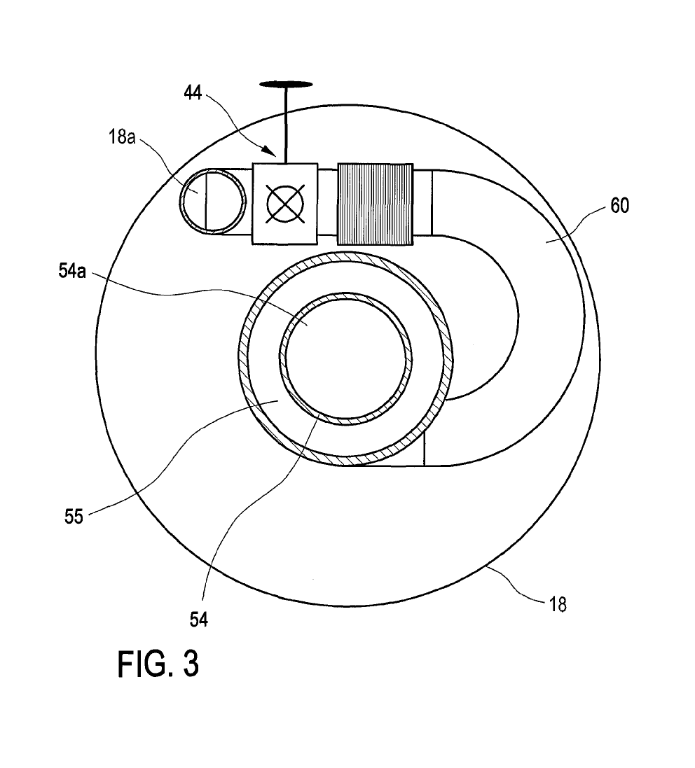

FIG. 3 is a partial view of a recuperator of a gas turbine arrangement according to a first embodiment of the present invention;

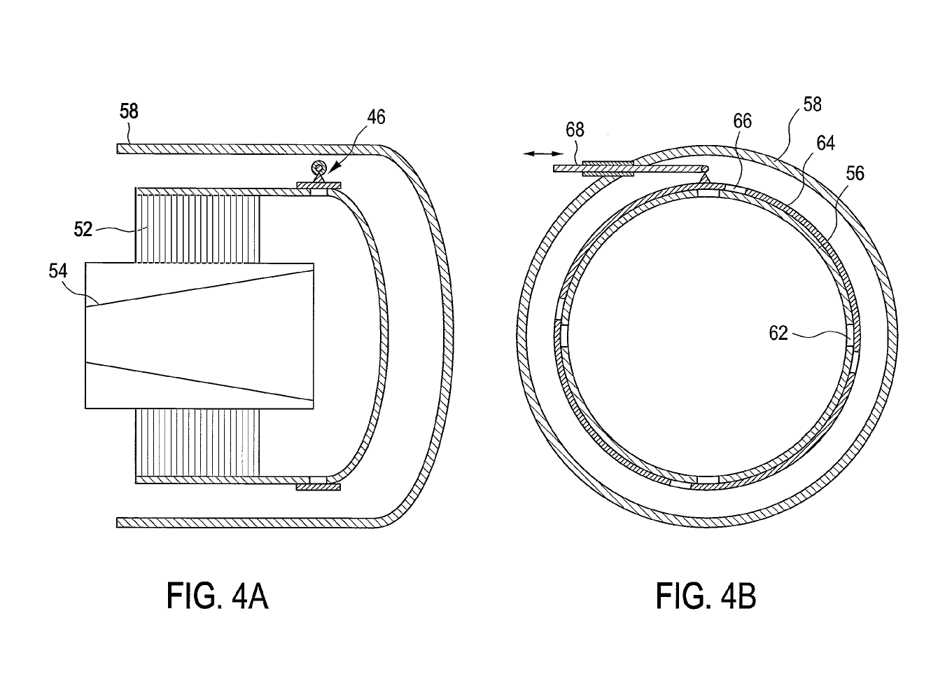

FIG. 4 is a partial view of a recuperator of a gas turbine arrangement according to a second embodiment of the present invention, in two different views;

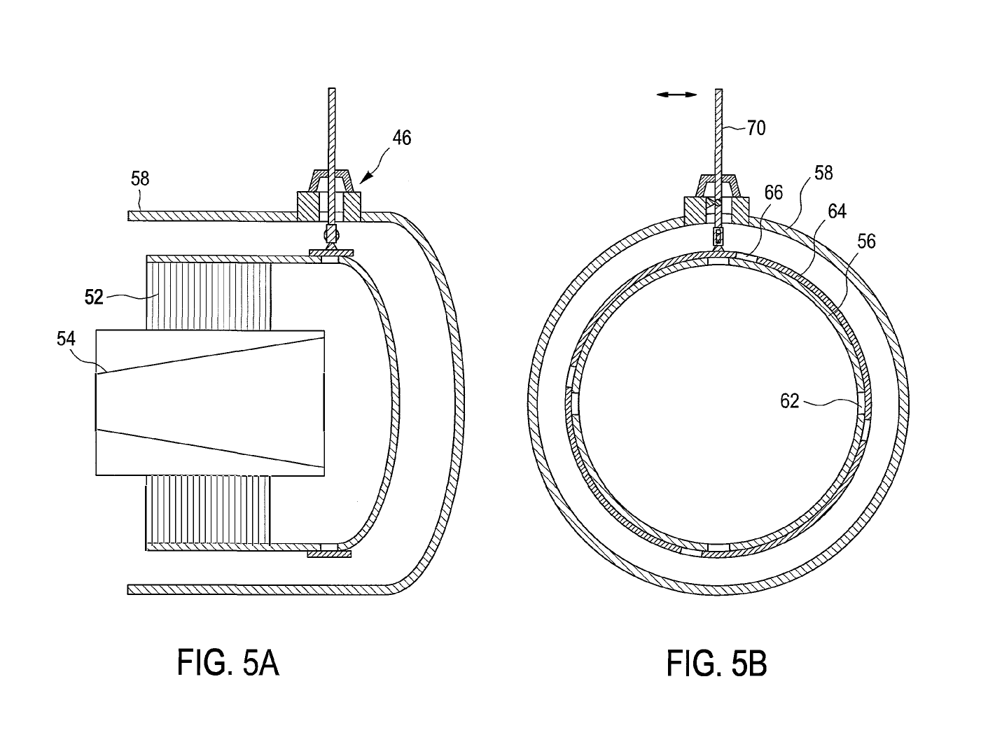

FIG. 5 is a partial view of a recuperator of a gas turbine arrangement according to a third embodiment of the present invention, in two different views;

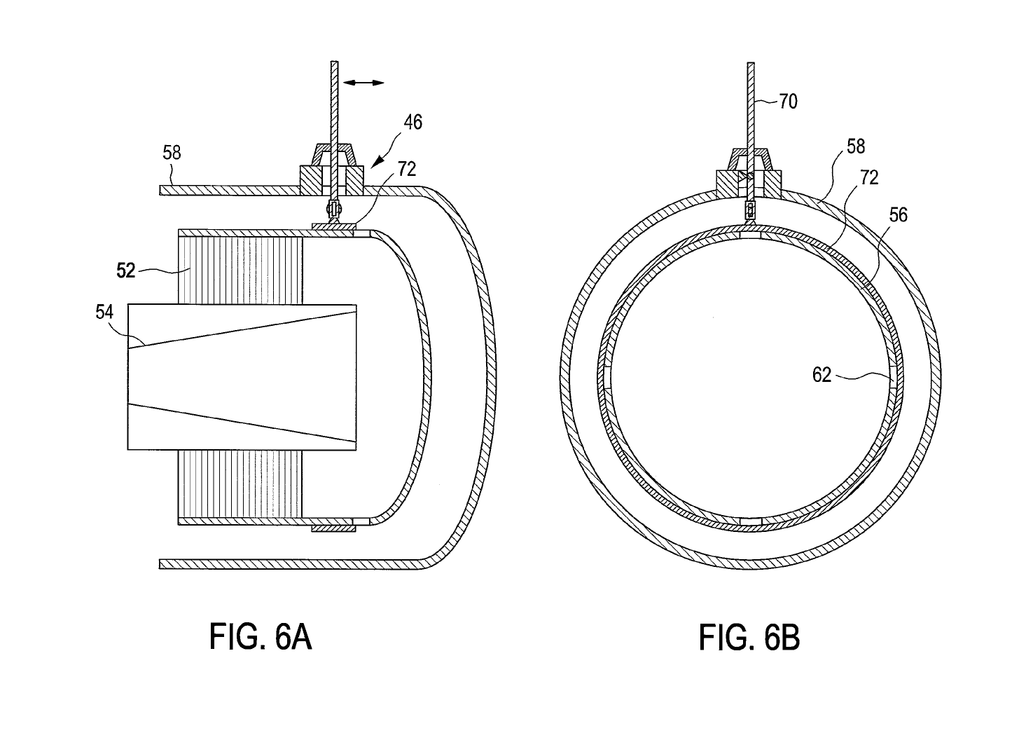

FIG. 6 is a partial view of a recuperator of a gas turbine arrangement according to a fourth embodiment of the present invention, in two different views;

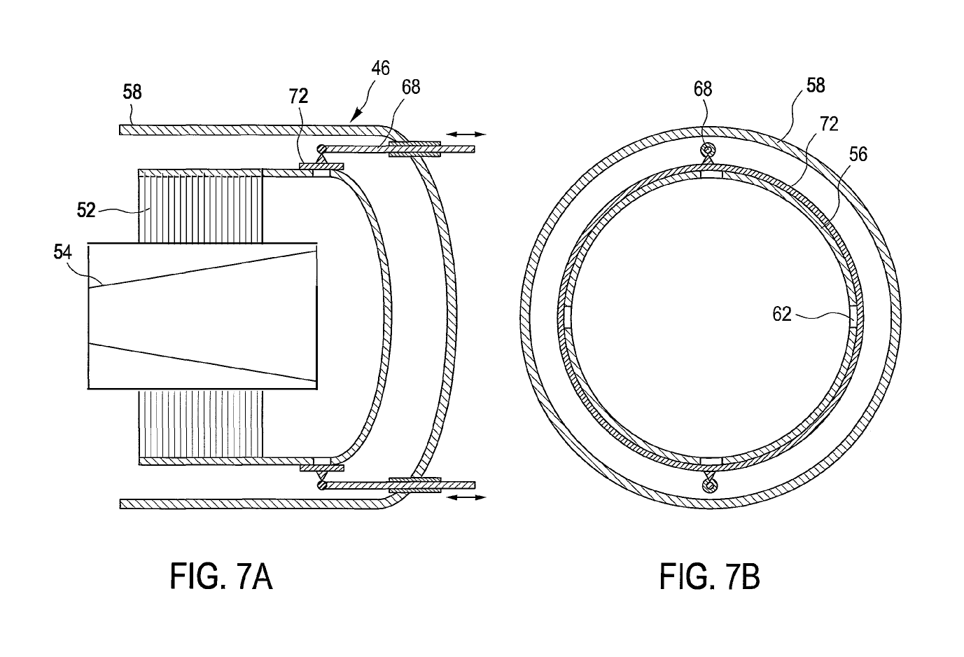

FIG. 7 is a partial view of a recuperator of a gas turbine arrangement according to a fifth embodiment of the present invention, in two different views;

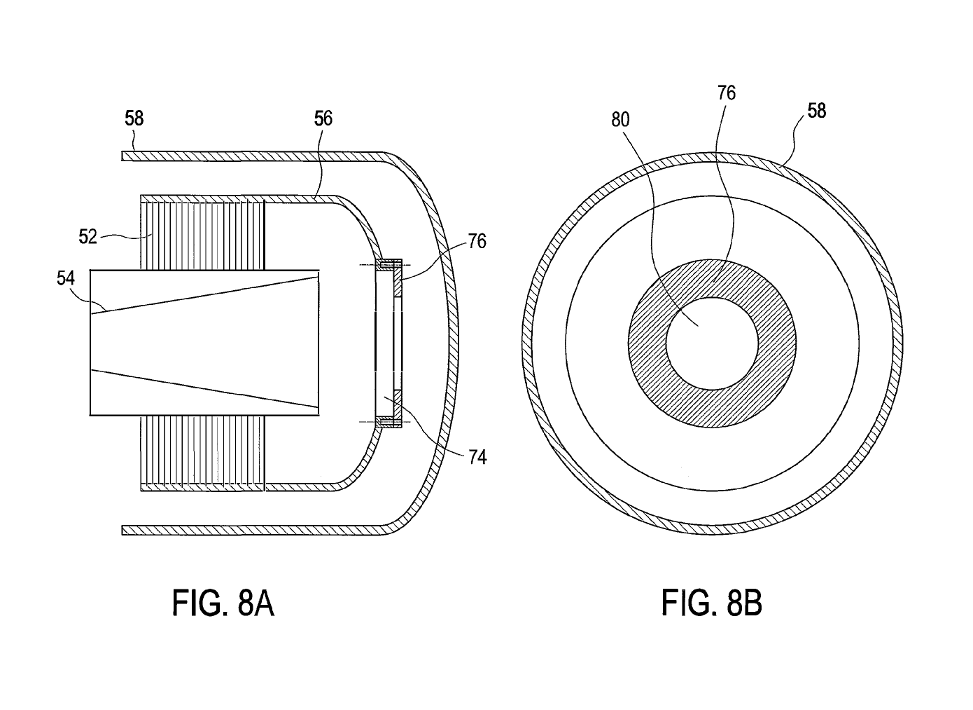

FIG. 8 is a partial view of a recuperator of a gas turbine arrangement according to a sixth embodiment of the present invention, in two different views;

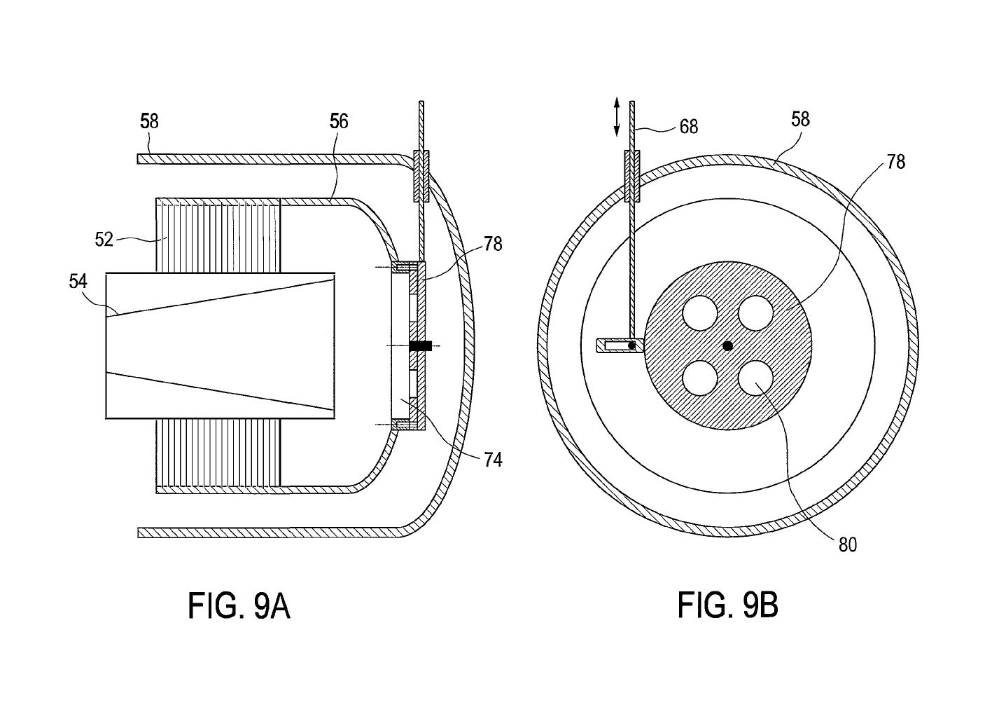

FIG. 9 is a partial view of a recuperator of a gas turbine arrangement according to a seventh embodiment of the present invention, in two different views;

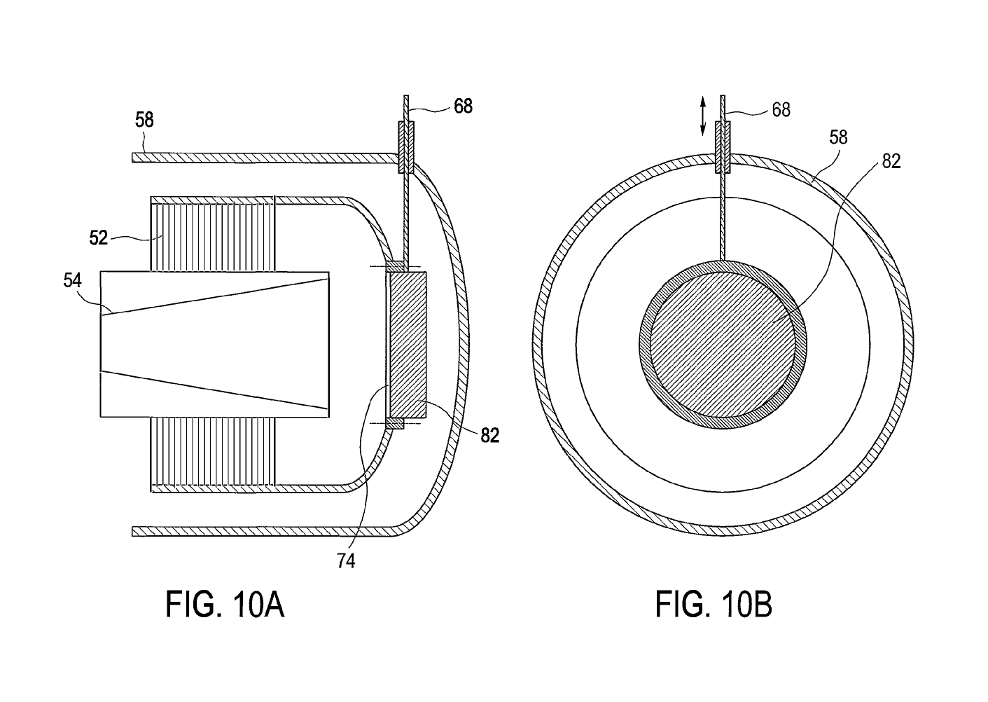

FIG. 10 is a partial view of a recuperator of a gas turbine arrangement according to an eighth embodiment of the present invention, in two different views;

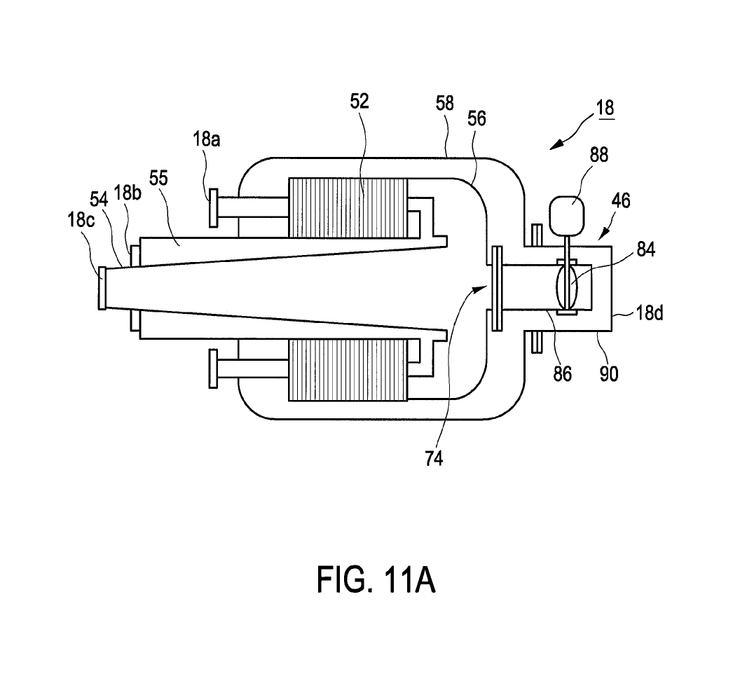

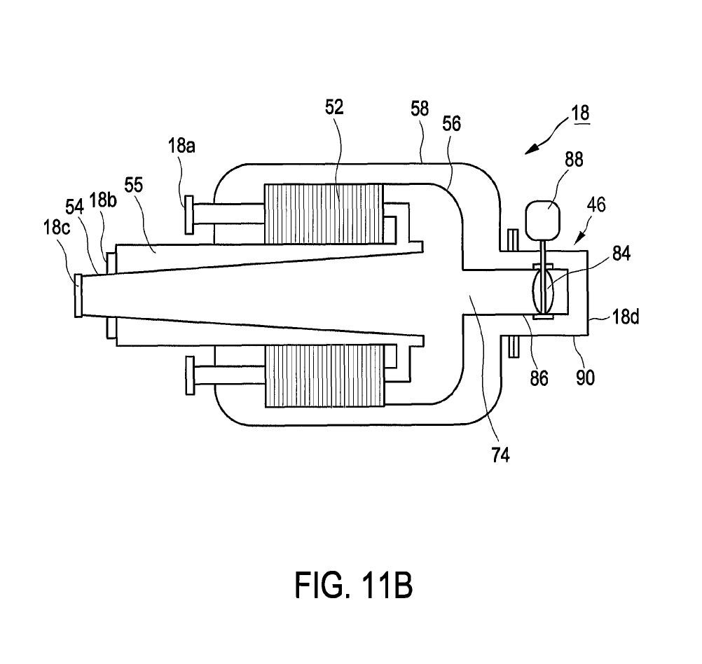

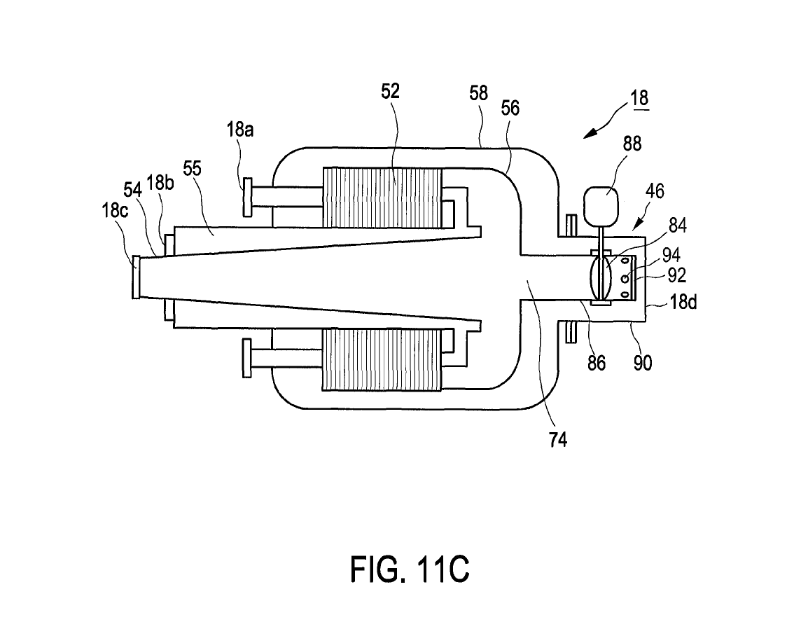

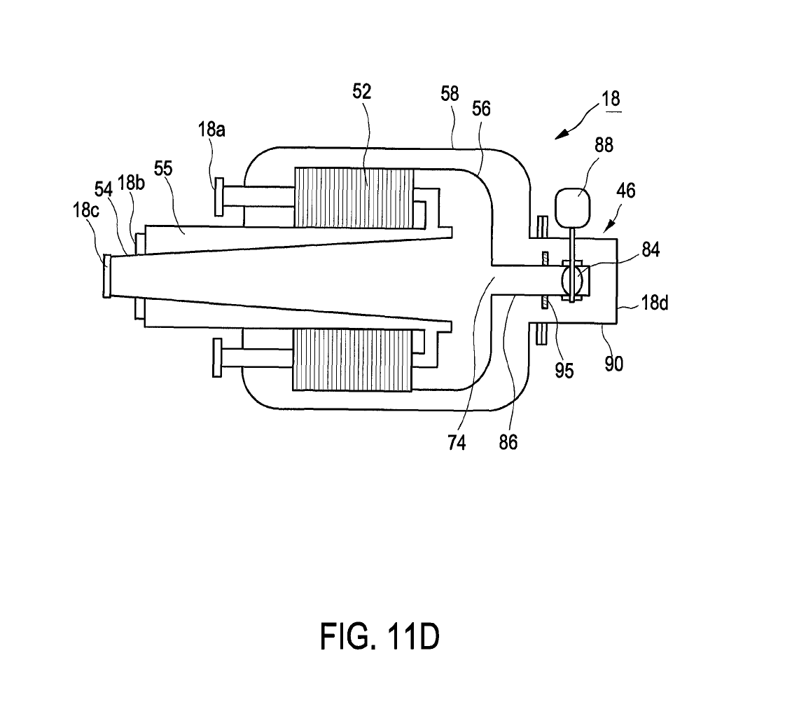

FIG. 11 are perspective partial views of a recuperator of a gas turbine arrangement according to a ninth embodiment of the present invention, in various embodyments, each in section along a longitudinal axis of the recuperator; and

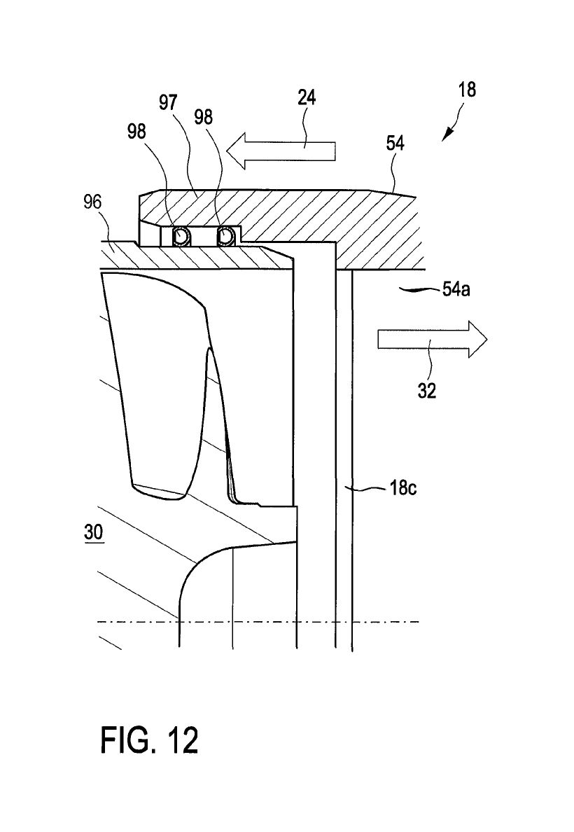

FIG. 12 is a partial sectional view of a connection of the recuperator to the gas turbine devices according to an embodiment of the present invention.

Referring to FIG. 1, at first, construction and operation of a power-heat cogeneration system are exemplarily described in more detail, in which a gas turbine assembly of the invention may be used advantageously.

The power-heat cogeneration system 10 of FIG. 1 has a gas turbine device 12, in particular a micro gas turbine device, a transducer 14 drive-connected to the gas turbine device 12, a waste heat device (e.g. heat exchanger) 16 supplied from the gas turbine device 12, and a recuperator 18. The nominal output of the micro gas turbine device 12 is particularly in a range from including 25 kW up to and including 1 MW, preferably in a range between 30 kW and 500 kW. A particularly preferred micro gas turbine device 12 has a nominal output of about 30 kW, 60 kW, 100 kW, 200 kW, 250 kW, 300 kW, or 400 kW.

The micro-gas turbine device 12 is configured as a single-shaft turbine having a central and continuous turbine shaft 20, and further comprises a compressor 22 for an oxidant stream 24, here combustion air, being arranged on the turbine shaft 20 in a rotationally fixed manner, a combustor system 28 for the combustion of a fuel with the compressed combustion air as well as a turbine 30 for relaxation of the resulting compressed and hot exhaust gases with simultaneous production of mechanical energy being arranged on the turbine shaft 20 in a rotationally fixed manner and fired by the combustor system 28. By relaxation of an exhaust gas stream formed from the exhaust gases 32 in the turbine 30, the turbine shaft 20 is driven in rotation, which in turn drives the compressor 22 mounted on the turbine shaft 20 and the transducer 14 also mounted thereon or drive-connected thereto. In the embodiment shown, the transducer 14 is an electrical generator for generating electrical energy, but it can also be a different kind of power engine for example for providing mechanical energy or a combination of both.

By means of the optionally provided heat exchanger 16, thermal power is removed from the exhaust gas stream 32 and fed to the heat user. In a configuration of the waste heat device 16 without heat exchanger, the exhaust gas stream 32 may be also used directly, for example, for a drying process.

In a first operating state or initial or normal state, combustion air is sucked by means of the compressor 22 from the environment. It may be expedient to use this sucked combustion air simultaneously as cooling air for the transducer 14 (e.g. if no further cooling of the transducer is required by doing so). The combustion air is compressed in the compressor 22 to a combustion air stream 24, depending on the application to 2 bar to 8 bar, and is heated thereby typically to temperatures of 100° C. to 300° C.

The compressed and thereby heated oxidant stream 24 is passed through a combustion air section of the recuperator 18 and is further heated thereby, Depending to the design of the recuperator and the bypass configuration, temperatures of typically 100° C. to 850° C., in particular between 200° C. and 750° C., preferably between 300° C. and 650° C., for example about 600° C. to 620° C. can be realized. In this state, the combustion air stream 24 is passed through the combustor system 28, into which also fuel is introduced via a fuel line 42.

An exhaust gas stream 32 having once more elevated temperature is produced by this combustion. The temperature at the outlet of the combustor or the inlet of the turbine is typically in the range of 800° C. to 1,100° C. The first operating state, however, may also be a partial load condition having lower turbine inlet temperature in the case of for example a lower mechanical or electrical energy demand at the transducer 14.

The exhaust gas stream 32 is expanded in the turbine 30 (depending on the application to e.g. about 1 bar to 2 bar), wherein its temperature drops to about 600° C. to 800° C. depending on the design and the turbine inlet temperature. This still hot exhaust gas stream 32 is passed through an exhaust gas section of the recuperator 18 which is flow-separated from but heat-transfereingly connected to the combustion air section. Here, a heat transfer from the exhaust gas stream 32 to the combustion air stream 24 occurs, wherein the combustion air stream 24 is heated as described above, and wherein the exhaust gas stream 32 is further cooled down to a usable temperature in accordance with the respective application of typically 200° C. to 750° C.

After passing through the recuperator 18, the exhaust gas stream 32 is passed to the waste heat device 16 having the optional heat exchanger and being positioned down-stream, where a first thermal power is provided at the waste heat device 16, and where the waste heat which is still present in the exhaust gas stream 32 cooled down to usable temperature can be discharged and made available as thermal energy by means of the waste heat device 16 as required. At the same time, in the first operating state described here, a first mechanical power is provided at the output device, here at the transducer 14, converted into electrical power in the generator, and supplied to the user.

As shown in FIG. 1, in addition, there are provided a compressor-side bypass 34 and an exhaust gas-side bypass 36. Optionally, only one of the two bypasses 34, 36 may be provided. By means of the compressor-side bypass 34, at least a portion of the compressed combustion air stream 24 can be diverted around a heat exchanger of the recuperator 18 (in FIG. 1 around the entire recuperator 18) and directly fed to the combustor system 28. By means of the exhaust gas-side bypass 36, at least a portion of the exhaust gas stream 32 can be diverted around a heat exchanger of the recuperator 18 (in FIG. 1 around the entire recuperator 18).

For controlling or regulating the mass flows in the power-heat cogeneration system 10, in addition there is provided a control means 38 which controls a control element 40 for controlling the flow through the fuel line 42, a control element 44 for controlling the flow through the compressor-side bypass 34, a control element 46 for controlling the flow through the exhaust gas-side bypass 36, a control element 48 for controlling the combustion air stream 24 into the recuperator 18, and a control element 50 for controlling the exhaust gas stream 32 through the recuperator 18. The control elements 40, 48, 50 each have, for example, a control element in the form of a control valve or a control throttle. The control elements 44, 46 of the two bypasses 34, 36 can be selectively configured as controllable control elements having a variable passage or as fixed control elements having a fixed passage, and they are described below in greater detail with reference to various embodiments.

With the help of the bypasses 34, 36, the gas turbine device 12 and thus the entire power-heat cogeneration system 10 can be operated with a better efficiency.

For the case of a changed need of heat at the heat exchanger 16 in comparison to the initial state described above for the same electro-mechanical energy output at the transducer 14, a second operating state can be caused, for which purpose the temperature of the exhaust gas stream 32 is modified in the area of the waste heat device 16. When increasing the need of useful heat at the waste heat device 16 in relation to the first operating state described above, the exhaust gas temperature of the exhaust gas stream 32 is increased by increasing the flow of combustion air through the compressor-side bypass 34. For this purpose, the control element 44 is opened via the control means 38 partially or completely, as required, resulting in diverting a more or less distinct partial stream of the combustion air stream 24, in case of completely open control element 44 even approximately the entire combustion air stream 24, around the combustion air section of the recuperator 18 instead of passing therethrough. As a result, only a reduced or no amount of heat is removed from the exhaust gas stream 32 in the recuperator 18.

The flow of the combustion air stream 24 through the combustion air section of the recuperator 28 can be throttled or even disabled completely by the other control element 48, to enforce a certain mass flow through the compressor-side bypass 34.

The control element 48 is—as shown here—preferably arranged on the inlet side of the recuperator 28, but may also be positioned on the outlet side thereof.

For temporarily increasing the temperature of the exhaust gas stream 32, the exhaust gas-side bypass 36 may be used alternatively or in addition. Thus, the exhaust gas temperature of the exhaust gas stream 32 can be increased by increasing the exhaust gas flow rate through the exhaust gas-side bypass 36, For this purpose, the control element 46 is opened partially or completely via the control means 38, as required, resulting in diverting a more or less distinct partial flow of exhaust gas stream 32, in case of a complete opened control element 46 even approximately the entire exhaust gas stream 32, around the exhaust gas section of the recupertaor 28 instead of passing therethrough. Only a reduced or even no amount of heat is removed from the exhaust gas stream 32 in the recuperator 28 subsequently, also in this manner.

By means of the further control element 50, the flow of the exhaust gas stream 32 through the exhaust gas section of the recuperator 18 can be throttled or even completely suppressed to enforce a certain mass flow through the bypass 36.

The control element 50 is—as shown here—preferably arranged on the outlet side of the recuperator 18, but may also be positioned on the inlet side thereof.

The two bypasses 34, 36 or their control elements 44, 46 may optionally be operated alternately or in combination with each other. Alternatively, one of the two bypasses 34, 36 may be omitted.

For achieving the second operating state, it is possible to change also the fuel mass flow introduced into the combustor system 28 by means of the control element 40 in the fuel line, alternatively to or in particular in combination with the above-described change of the flow through the bypasses 34, 36, and preferably substantially in synchronism with the change of the flow through the bypasses 34, 36.

FIG. 2 illustrates the structure of a preferred embodiment of a recuperator 18, as it can be used in a power-heat cogeneration system of FIG. 1. For more clearness, no bypasses 34, 36 are shown in FIG. 2.

In this embodiment, the recuperator 18 is arranged in axial direction next to the gas turbine device 12. In other words, the longitudinal axis of the recuperator 18 extends (in left/right direction in FIG. 2) substantially coaxially with the turbine shaft 20 of the gas turbine device 12 or only slightly offset in parallel to it.

The recuperator 18 includes a diffuser 54 whose central inflow channel 54a extends substantially coaxially with the turbine shaft 20 of the gas turbine device 12, and a heat exchanger 52 annularly surrounding the diffuser 54. The diffuser 54 and the heat exchanger 52 are arranged within an outer shell 58 which forms a housing of the recuperator 18. For formation of the flow channels for the exhaust gas stream 32, in addition, an inner shell 56 is provided within the outer shell 58.

The oxidant stream 24 and the exhaust gas stream 32 directed through the recuperator 18 in a way fluidically separated from each other. For this purpose, the diffuser 54 has an inlet side connected to a second inlet 18c of the recuperator 18 for the exhaust gas stream 32, Downstream of the diffuser 54, the exhaust stream 32 deflected by the inner shell 56 and directed into the heat exchanger 52. After flowing through the heat exchanger 52, the exhaust gas stream is deflected again and is finally output through an axial second outlet 18d of the recuperator 18 on a side facing away from the gas turbine device 12 (on the right in FIG. 2). The outer shell 58 has a first inlet 18a for the oxidant stream 24 on its side facing the gas turbine device 12 (on the left in FIG. 2) which is connected to the heat exchanger 52. After flowing through the heat exchanger 52, the oxidant stream 24 is directed into an annular gap 55 of the diffuser 54 and directed therein to a first outlet 18b of the recuperator 18 on the side of the recuperator 18 facing the gas turbine device 12.

In the heat exchanger 52 of the recuperator 18, the exhaust gas stream 32 heated up in the combustor system 28 releases a portion of its thermal energy to the compressed oxidant stream 24. In this embodiment, the oxidant stream 24 and exhaust gas stream 32 flow through the heat exchanger 52 in opposite directions.

Referring now to FIGS. 3 to 10, various embodiments of the gas turbine arrangement including the gas turbine device 12 and the recuperator 18, and in particular of their bypasses 34, 36 are described in more detail. The recuperator 18 is preferably constructed as the recuperator 18 illustrated in FIG. 2.

FIG. 3 shows an embodiment having a compressor-side bypass 34.

In the embodiment of FIG. 3, the first inlet 18a of the recuperator 18 is directly, i.e. while bypassing the heat exchanger 52, connected to the annular gap 55 of the diffuser 54, via a connecting pipe 60. In such a pipe connection between the compressor outlet and the annular gap leading to the combustor system 28, the mass flow distribution is preferably set by means of an inserted aperture plate or a valve element (valve, flap, slide or the like). The connecting pipe 60 shall preferably be isolated, because otherwise heat loss will occur or the high temperature requires a contact protection.

In case the bypass mass flow with fully opened bypass valve 44 is insufficient, it may be necessary to mount an additional throttle valve at the compressor inlet 18a of the recuperator 18. hereby, the mass flow can be further increased when the bypass valve 44 is fully open.

Instead of the adjustable control element 44 shown in FIG. 3, the compressor-side bypass 34 may also comprise a fixed control element having a fixed predetermined port such as a diaphragm, an aperture plate, a hole pattern or the like.

FIGS. 4 to 11 show various embodiments having an exhaust gas-side bypass 36.

The exhaust gas-side bypass 36 is preferably implemented downstream of the diffuser 54 in the recuperator 18. Here, both radial openings 62 in the inner shell 56 (see FIGS. 4 to 7) and axial openingas 74 in the inner shell (see FIGS. 8 to 11) are possible. Both variants can by implemented by fixed control elements (diaphragms, aperture plates, hole patterns, etc,) or adjustable control elements (valves, flaps).

In the embodiment of FIG. 4A and 4B, a plurality of radial openings 62 is provided in the inner shell 56 downstream of the diffuser 54. These form an exhaust gas-side bypass 36 through which the exhaust gas stream 32 can flow from the diffuser 54 directly into the interior of the outer shell 58 while at least partly bypassing the heat exchanger 52, and from there to the second outlet 18d.

In the embodiment of FIGS. 4A and 4B, the variable control element 46 comprises a ring element in the form of a rotary ring 64 which surrounds the hole pattern 62 in the inner shell 56 in the circumferential direction and is movable in the circumferential direction by means of an adjustment rod (push/pull rod, etc.) 68. The rotary ring 64 also has a plurality of arbitrarily shaped openings 66 which can cover the openings 62 of the inner shell 56 partially or completely. By turning the rotary ring 64 by means of the adjustment rod 68, the released flow cross-section of the bypass 36 can be varied. Advantageously, the external adjustment option without changing the thermal insulation, and the good mixing of hot and cold exhaust gas stream by cross-mixing.

The embodiment shown in FIGS. 5A and 5B differs from the embodiment of FIGS. 4A and 4B in the type of the control element 46. In the embodiment of FIGS. 5A and 5B, the control element 46 comprises an adjustment lever 70 for turning the rotary ring 64, instead of the adjustment rod 68. Apart from that, the construction of the recuperator 18 of FIGS. 5A and 5B corresponds to that of FIGS. 4A and 4B.

The embodiment shown in FIGS. 6A and 6B differs from the embodiment of FIGS. 4A and 4B also in the type of the control element 46. In the embodiment of FIGS. 6A and 6B, the control element 46 comprises a slide ring 72 being movable in axial direction, instead of the rotary ring 64 being movable in circumferential direction. In contrast to the rotary ring 64, the slide ring 72 has no hole pattern. The control element comprises an adjustment lever 70 to move the slide ring 64. Apart from that, the construction of the recuperator 18 of FIGS. 6A and 6B corresponds to that of FIGS. 4A and 4B.

The embodiment shown in FIGS. 7A and 7B differs from the embodiment of FIGS. 6A and 6B in that an adjustment rod 68 (push/pull rod) operable in axial direction is provided instead of the adjustment lever 70. Apart from that, the construction of the recuperator 18 of FIGS. 7A and 7B corresponds to that of FIGS. 6A and 6B.

While in the embodiments of FIGS. 4 to 7 the plurality of radial openings 62 in the inner shell 56 of the recuperator 18 each can be opened and closed by a common control element 46, in other embodiments of the invention it is also possible to provide a plurality of separate control elements which can each open and close individual radial openings 62 or individual groups of radial openings 62. The plurality of control elements is preferably controlled synchronously.

In the embodiments having radial openings 62, the passage area thereof is in a range of about 0.025 m² to 0.035 m², for example at about 0.031 m², in total. The passage areas of the individual radial openings 62 can either be of substantially the same size or different from each other. The number of the radial openings 62 is preferably in the range of 4 to 100.

Specific embodiments of the recuperator 18 comprise for example four radial openings 62 having a diameter of about 100 mm, sixteen radial openings 62 having a diameter of about 50 mm, or sixty-four radial openings 62 having a diameter of about 25 mm.

In the embodiments of the recuperator 18 having radial openings 62 in the inner shell 56, a good mixture of colder and warmer partial air streams can be achieved by the cross-flow in radial direction and the two flow deflections.

In the embodiment of FIGS. 8A and 8B, a central axial opening 74 is provided in the inner shell 56 downstream of the diffuser 54. This opening forms an exhaust gas-side bypass 36 through which the exhaust gas stream 32 can flow from the diffuser 54 directly into the interior of the outer shell 58 while at least partly bypassing the heat exchanger 52, and from there to the second outlet 18d.

In the embodiment of FIGS. 8A and 8B, the fixed control element 46 has a mounting ring at the opening 74 of the inner shell 56 into which an aperture plate 76 is inserted in the simplest case. This aperture plate 76 is preferably exchangeable in order to enable adaption of the flow cross section through the bypass 36. An external change in mass flow distribution is not possible in this embodiment. Here, the exhaust gas stream 32 flows from the diffuser 54 without deflection directly to the second outlet 18d and from there into the exhaust gas line downstream of the recuperator 18.

The embodiment shown in FIGS. 9A and 9B differs from the embodiment of FIGS. 8A and 8B in the type of the control element 46, In the embodiment of FIGS. 9A and 9B, the control element 46 comprises a variable control element 46 in the form of a rotary aperture plate 78 which is turnable by means of an adjusting rod to selectively overlap the openings 80 with the openings in the aperture plate, instead of the fixed control element in the form of an aperture plate 76. Apart from that, the construction of the recuperator 18 of Figs, 9A and 9B corresponds to that of FIGS. 8A and 8B.

The embodiment shown in FIGS. 10A and 10B differs from the embodiment of FIGS. 8A and 8B also in the type of the control element 46. In the embodiment of FIGS. 10A and 10B, the control element 46 comprises a variable control element in the form of a valve element (valve, flap, slide valve, slotted disc, etc.) which can selectively be opened or closed by means of an adjusting rod, instead of the fixed control element in the form of an aperture plate 76. Apart from that, the construction of the recuperator 18 of FIGS. 10A and 10B corresponds to that of FIG. 8A and 8B.

In the embodiments having axial openings 74 in the inner shell 56 of the recuperator 18, the passage area thereof is in a range of about 0.025 m² to 0.035 m², for example at about 0.031 m², in total. The passage areas of the individual axial openings 74 can either be of substantially the same size or different from each other. The number of the axial openings 74 is preferably in the range of 4 to 100.

Specific embodiments of the recuperator 18 include, for example, four axial openings 74 having a diameter of about 100 mm, sixteen axial openings 74 having a diameter of about 50 mm, or sixty-four axial openings 74 having a diameter of about 25 mm.

FIGS. 11A to D show various configuration variants of a control element 46 for the exhaust gas-side bypass 36 integrates into the recuperator 18, in the event of an axial opening 74 in the inner shell 56 of the recuperator.

As shown in FIG. 11A, the inner shell 56 of the recuperator 18 has an axial opening 74 which is oriented substantially coaxially to the longitudinal axis of the diffuser 54. The actuating element 46 for the exhaust gas-side bypass 36 is configured as a valve member having a valve flap 84. The actuating member 46 in particular comprises a connection socket 86 being fluidically connected to the axial opening 74, the valve flap 84 arranged in the connection socket 86, and an actuator 88 connected to the control means 38 for adjusting the valve flap 84. The control element 46 further comprises a further connection socket 90 which is arranged substantially coaxially with the connection socket 86 and is fluidically connected to the intermediate space between the inner shell 56 and outer shell 58 of the recuperator 18. The further connection socket 90 also serves as a mounting aid for the actuator 88 of the valve flap 84.

In the embodiment of FIG. 11A, the connection socket 86 of the control element 46 is flanged to the axial front end of the inner shell 56 around the axial opening 74.

Further, in the embodiment of FIG. 11A, the downstream end of the connection socket 86 is configured open so that the exhaust gas stream 32 flown through the valve element of the bypass 36 can exit from the connection socket 86 at the front end and, eventually, mix with the warmer exhaust gas stream 32 having flown not through the bypass 36 but through the heat exchanger 52 of the recuperator 18, before the exhaust gas stream 32 leaves the recuperator 18.

The embodiment of the adjustment element 46 shown in FIG. 11D differs from the embodiment shown in FIG. 11B in that the flow diameter of the connection socket 86 is dimensioned smaller. With a smaller dimensioned valve, smaller leakage rates can be achieved and the control quality can be improved, in particular at a temperature increase of the exhaust gas stream 32. In order to increase the mass flow through the valve element 46, in this embodiment, the correspondingly wider annular clearance between the connection socket 86 and the further connection socket 90 is preferably narrowed. In the embodiment of FIG. 11D, this narrowing is achieved by an orifice plate 95 that is arranged radially around the connection socket 86.

Finally, FIG. 12 shows an embodiment for a connection of the recuperator 18 to the gas turbine device 12 in which the recuperator 18 is arranged next to the gas turbine devive 12 in axial direction of the turbine shaft 20 of the gas turbine device.

As shown in FIG. 12, the turbine 30 of the gas turbine device 12 comprises a circumferential counter-contour 96 in its downstream region, on which a circumferential, axially projecting wall projection 97 of the diffuser 54 of the recuperator 18 is slidden in axial direction, i.e. parallel to the axis of the turbine shaft 20 (so-called sliding seat). In order to prevent leakage between the combustion air stream 24 heated by the recuperator 18 and the exhaust gas stream 32, a radial sealing is provided between the counter-contour 96 of the turbine 30 and the wall projection 97 of the diffuser 54 which sealing preferably forms a quasi-static sealing. In the embodiment of FIG. 12, this radial sealing comprises two C-ring seals 98, preferable made of metal, arranged one behind the other. In other embodiments of the invention, the radial sealing may comprise different sealing elements such as lamellar seal rings, labyrinth seals, brush seals, O-ring seals and the like.

When using different gas turbine arrangements and their recuperators 18 which do not correspond to the construction shown in FIG. 2, correspondingly modified constructions for the bypasses 34, 36 and their control elements 44, 46 are possible.

Thus, for example, for a recuperator 18 being arranged annular outside the gas turbine device 12, a partial mass flow can be directed on the inside of the recuperator 18 to the combustor system 28, on the compressor side. For adjusting the mass flow, various opening patterns (patterns of drilling) can also be used. On the exhaust gas side, the bypass 36 can be implemented for example by means of a piping between exhaust gas chimney and the diffuser outlet or by means of an annular channel around the core of the recuperator. For adjusting the bypass mass flow, radial openings can also be used here, which may be adapted or adjusted as needed.

In a recuperator 18 in the form of a plate heat exchanger, on the compressor side, for introducing the diverted mass flow 24 into the annular gap between the recuperator 18 and the combustor system 28, alternatively the partial mass flow may be introduced into a collecting line between the recuperator 18 and the annular gap.

In a plate heat exchanger, the compressor-side bypass may be configured for example by a piping between the supply line to the recuperator and the annular gap of the hot gas supply to the combustor system or a piping between the supply line and a hot gas side piping. On the exhaust gas side, the bypass may be implemented by attaching a flow channel at the top and/or bottom side of the recuperator having a connection to the exhaust gas-side inflow and outflow sockets.

### LIST OF REFERENCE SIGNS

10 power-heat cogeneration system
12 gas turbine device
14 transducer (e.g. generator)
16 waste heat device (e.g. heat exchanger)
18 recuperator
18a first inlet (oxidant stream)
18b first outlet (oxidant stream)
18c second inlet (exhaust gas stream)
18d second outlet (exhaust gas stream)
20 turbine shaft
22 compressor
24 oxidant stream (e.g. combustion air stream)
28 combustor system
30 turbine
32 exhaust gas stream
34 compressor-side bypass
36 exhaust gas-side bypass
38 control means
40 control element
42 fuel line
44 control element
46 control element
48 control element
50 control element
52 heat exchanger
54 diffuser
54a inflow channel
55 annular gap
56 inner shell
58 outer shell
60 connecting pipe
62 radial opening
64 rotary ring
66 opening
68 adjustment rod
70 adjustment lever
72 slide ring
74 axial opening
76 aperture plate
78 rotary aperture plate
80 opening
82 valve element
84 valve flap
86 connection socket
87 open end
88 actuator
90 further connection socket
92 closure
94 radial flow openings
95 flow restrictor
96 counter-contour of the turbine
97 wall protrusion of the diffuser
98 C-ring seals

1. A gas turbine arrangement, in particular a micro gas turbine arrangement, comprising:
a gas turbine device comprising a combustor system, a turbine driven by an exhaust gas stream of said combustor system and a compressor for supplying said combustor system with a compressed oxidant stream;
a recuperator for transferring at least a portion of the thermal power of said exhaust stream of said turbine to said compressed oxidant stream;
at least one bypass for diverting at least a portion of said oxidant stream or said exhaust gas stream around at least one heat exchanger of said recuperator; and
at least one control element for adjusting the flow through said at least one bypass.

2. The gas turbine arrangement according to claim 1, characterized in that said recuperator is arranged coaxially with a turbine shaft of said gas turbine device next to said gas turbine device.

3. The gas turbine arrangement according to claim 1, characterized in that said recuperator is arranged in a radial direction of a turbine shaft of said gas turbine device, preferably concentrically around said gas turbine device.

4. The gas turbine arrangement according to claim 1, characterized in that said at least one bypass is integrated into said recuperator.

5. The gas turbine arrangement according to claim 1, characterized in that at least one compressor-side bypass connecting a first inlet of said recuperator for said oxidant stream to a first outlet of said recuperator for said oxidant stream while bypassing the heat exchange of said recuperator is provided.

6. The gas turbine arrangement according to claim 1, characterized in that at least one exhaust gas-side bypass connecting a second inlet of said recuperator for said exhaust gas stream to a second outlet of said recuperator for said exhaust gas stream while bypassing the heat exchanger of said recuperator is provided.

7. The gas turbine arrangement according to claim 6, characterized in that said recuperator comprises a diffuser extending substantially concentrically with a turbine shaft of said gas turbine device extending diffusor, which diffuser on its inlet side is connected to said second inlet of said recuperator for said exhaust gas stream, wherein said exhaust gas-side bypass is provided downstream of said diffuser.

8. The gas turbine arrangement according to claim 6, characterized in that said recuperator comprises an inner shell and an outer shell enclosing said inner shell, that said inner shell on its inlet side is connected to said second inlet of said recuperator and said outer shell on its outlet side is connected to said second outlet of said recuperator, and that said exhaust gas-side bypass connects the interior of said inner shell in radial direction to the interior of said outer shell.

9. The gas turbine arrangement according to claim 8, characterized in that said exhaust gas-side bypass has at least two radial openings in said inner shell, and said control element comprises a ring element being slidable in circumferential direction or in axial direction for selectively opening or closing said at least two radial openings.

10. The gas turbine arrangement according to claim 6, characterized in that said recuperator comprises an inner shell and an outer shell enclosing said inner shell, that said inner shell on its inlet side is connected to said second inlet of said recuperator and said outer shell on its outlet side is connected to said second outlet of said recuperator, and that said exhaust gas-side bypass connects the interior of said inner shell in axial direction to the interior of said outer shell.

11. The gas turbine arrangement according to claim 10, characterized in that said control element for said exhaust gas-side bypass is integrated into said recuperator and comprises a connection socket being fluidically connected to an axial opening in said inner shell, a valve flap arranged in said connection socket, and a further connection socket being fluidically connected to an intermediate space between said inner shell and said outer shell.

12. A recuperator for a gas turbine arrangement according to claim 1.

13. A power-heat cogeneration system, comprising at least one gas turbine arrangement according to claim 1.

14. A method for operating a gas turbine arrangement, in particular a micro gas turbine arrangement, comprising: a gas turbine device having a combustor system; a turbine driven by an exhaust gas stream of said combustor system; and a compressor for supplying said combustor system with a compressed oxidant stream; as well as a recuperator for transferring at least a portion of the thermal power of said exhaust stream of said turbine to said compressed oxidant stream;
at least a portion of said oxidant stream and/or said exhaust gas stream is diverted around at least one heat exchanger of said recuperator by means of at least one bypass; and
a flow through said at least one bypass is adjusted in an application specific and/or variable way.
